(19) United States
(12) Patent Application Publication
(10) Pub. No.: US 2022/0257055 A1
(43) Pub. Date: Aug. 18, 2022

(54) GRILLING GRATE FOR A GRILLING APPARATUS

(71) Applicant: Robert Falken, Encinitas, CA (US)

(72) Inventor: Robert Falken, Encinitas, CA (US)

(21) Appl. No.: 17/175,666

(22) Filed: Feb. 14, 2021

(51) Int. Cl. A47J 37/07

(52) U.S. Cl. CPC A47J 37/0786

(57) ABSTRACT

An improved grilling grate comprising a plurality of food-safe metal cladded highly heat conductive elongated rods formed by encapsulating a highly heat conductive core and an outer surface of the highly heat conductive core with a food-safe exterior metal that is circumferentially cladded. The mounting assembly of the improved grilling grate includes mounting elements that are preferably connected to an inner surface of a grilling apparatus. The improved grilling grate of the present invention can be manually placed into position within the grilling apparatus mounting assembly or be slidable into position within the same.

### BACKGROUND

The present invention relates to apparatuses and methods for grilling and/or smoking foodstuffs. More particularly, the present invention relates to an improved grilling grate for a grilling apparatus, such as a barbecue grill. Even more particularly, the present invention relates to an improved grilling grate comprised of a plurality of food-safe metal cladded, highly heat conductive elongated rods assembled in a nesting relationship to form a cooking surface for a grilling apparatus, such as a barbecue grill.

The plurality of food-safe metal cladded, highly heat conductive elongated rods are assembled to form the improved grilling grate of the present invention, whereby so-called elongated placement rods extend generally horizontally and generally parallel to one another. These elongated placement rods are positioned such that there is sufficient space between each elongated rod to directly support foodstuffs over a heating source, such as a flame, fire, or smoke. The elongated placement rods of mention intersect the one or more elongated outer edge rods, which are hereinafter known as the elongated perimeter rods, whereby one or more elongated crossbar rods are affixed by their end points to the one or more elongated perimeter rods in such a way that they run perpendicular to and intersect the elongated placement rods. The one or more elongated crossbar rods of mention are in turn affixed directly to the bottom working surface of the elongated placement rods at their respective intersection points. The length of the elongated placement rods and elongated crossbar rods of mention are such that they contact the elongated perimeter rods, but do not extend beyond the elongated perimeter rods outer edge. The number, size and diameter of the food-safe metal cladded, highly heat conductive elongated rods of the present invention will vary depending on factors such as the desired grilling apparatuses size, shape, heat source type, foodstuff type, and food preparation method.

Typically, grilling and/or smoking foodstuffs includes the use of an apparatus, such as a barbecue grill or a smoker grill. These apparatuses come in a variety of shapes and sizes with typical heat source types consisting of briquettes, charcoal, electric, infrared, natural gas, propane, wood, or wood pellets. Further, in addition to grilling and/or smoking foodstuffs, additional food preparation methods consist of baking, barbequing, braising, roasting, as well as cooking, warming, and other methods of preparing foodstuffs known by those skilled in the art. What nearly every conceivable grilling and/or cooking apparatus has in common is that they contain one or more conventional monometallic grilling grates, also known as grilling grids or grilling racks, adjacent to a heating source. In some instances, certain grilling apparatuses include one or more warming grilling grates positioned away from the heating source such that a user can move cooked foodstuffs away from the grilling grate that is abutting the heating source. The warming grilling grate of mention allows the user to move cooked foodstuffs further away from the heating source in order to keep the cooked foodstuffs warm, but not overcooked. The warming grill grate of mention also allows the user to free up space on the grilling grate that is abutting the heating source for cooking more foodstuffs thereto.

An example of a conventional monometallic grilling grate is described in U.S. Pat. No. 5,490,452, in which a grilling grate is comprised of a combination of monometallic elongated rods with spacing therebetween. The monometallic elongated rods of mention are attached to a circular perimeter ring thereby forming the conventional monometallic grilling grate. The shape of the circular grilling grate of mention corresponds to the shape of the appropriate receiving portion of a grilling apparatus. A further example of a conventional monometallic grilling grate is described in U.S. Pat. No. 6,481,343, in which a grilling grate is comprised of a combination of monometallic elongated rails with spacing therebetween. The monometallic elongated rails of mention are nested in a generally rectangular shape thereby forming the conventional monometallic grilling grate. The shape of the grilling grate of mention corresponds to the shape of the appropriate receiving portion of a grilling apparatus.

Various types of metal cladded elongated rods and methods of manufacturing the same are known in the art. Several non-limiting examples of the manufacturing methods used for producing metal cladded elongated rods are roll-bonding processes or cold-rolling processes as generally described in U.S. Pat. No. 3,220,107 or U.S. Pat. No. 3,320,666. Further, alternate methods of metal cladding elongated rods consist of a welding-seam method of cladding as evidenced in U.S. Pat. No. 3,562,899. In certain instances, metal cladded elongated rods can be heat treated subsequent to cladding as a means to overcome the effects of mechanical deformation and to enhance the metallurgical bond strength of the resulting cladded rod as described in U.S. Pat. No. 2,753,623. None of the above referenced patent citations teach of manufacturing food-safe metal cladded, highly heat conductive elongated rods that are assembled to form the improved grilling grate of the present invention, and as such, they are being provided hereinafter as reference material only.

Unfortunately, known monometallic elongated grilling rods, rails, or bars assembled to form grilling grates for use in grilling apparatuses fail to evenly distribute heat for grilling and/or smoking foodstuffs, while at the same time also being low in maintenance and of high durability. By way of non-limiting example, attendants must often accept tradeoffs such as the advantage of well-known monometallic cast iron grilling grates providing high thermal conductivity, while also accepting disadvantages such as rapid oxidizing or rusting, and the repeatedly required maintenance of carbonized oil seasoning. Further, foodstuffs are known to easily adhere to monometallic cast iron grilling grates, and this can create the attendant determent of burnt foodstuffs unless they are properly and regularly maintained. Further still, known monometallic grilling grates, like those made from porcelain enameled steel for example, can contribute to inconsistent heating, heat limitations, and the porcelain enamel is prone to chipping and this can lead to the grates rusting and becoming defective. For these reasons and more, there are a number of disadvantages in known monometallic grilling grates for grilling apparatuses that can be addressed.

It is a primary object of the present invention to provide an improved grilling grate and method of manufacturing the same that provides maximum heat consistency with even heat distribution without attendant detriments.

It is a further object of the present invention to provide an improved grilling grate and method of manufacturing the same that provides optimal thermal conductivity, and that retains heat for desirable durations of time.

Still a further object of the present invention is to provide an improved grilling grate and method of manufacturing the same that provides a low-maintenance, highly durable, food-safe surface with which to directly support foodstuffs over a heating source for grilling and/or smoking foodstuffs thereto.

### SUMMARY

Implementations of the present invention provide improved grilling grates for grilling apparatuses, as well as components thereof, and methods of assembling the same that solve one or more of the foregoing or other problems in the art.

For example, one or more implementations of the present invention can include a barbecue grill that includes grilling grate mounting elements that are connected to an inner surface thereto. In certain instances, the grilling grate mounting elements may be directly affixed to a grilling grate, or to both an inner surface of a barbecue grill and a grilling grate itself. Additionally, an area disposed within the barbecue grill of mention is provided for accepting at least one improved grill grate of the present invention in proximity of the desired heating source therein. The barbecue grill can be adapted for optimal use by providing the appropriately sized diameters of both the food-safe metal cladding and highly heat conductive core of the food-safe metal cladded highly heat conductive elongated rods within the improved grilling grate of the present invention for the chosen barbecue grill size, shape, heat source type, foodstuff type, and food preparation method. Further, the food-safe metal cladded highly heat conductive elongated rods of the improved grilling grate of the present invention are preferably round stock, but may be square stock, hexagon stock, or any other desirable stock shape.

The details of one or more embodiments are set forth in the accompanying drawings and the description below. Other objects and features of the present invention will become apparent from consideration of the following description taken in conjunction with the accompanying drawings.

### BRIEF DESCRIPTION OF THE DRAWINGS

The drawings illustrate the design and utility of preferred embodiments of the present invention, in which similar elements are referred to by common reference numerals. In order to better appreciate how the above-recited and other advantages and objects of the present invention are obtained, a more particular description of the present invention briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a perspective view of a grilling apparatus having an improved grilling grate according to an implementation of the present invention;

FIG. 2 illustrates a perspective view of an improved grilling grate assembly made in accordance with the principles of the present invention;

FIGS. 3 illustrates a perspective view of another improved grilling grate assembly made in accordance with the principles of the present invention;

FIG. 4 illustrates a sectional view of a highly heat conductive elongated rod made in accordance with the principles of the present invention.

### DETAILED DESCRIPTION

A description of embodiments of the present invention will now be given with reference to the Figures. It is expected that the present invention may take many other forms and shapes, hence the following invention is intended to be illustrative and not limiting, and the scope of the invention should be determined by reference to the appended claims.

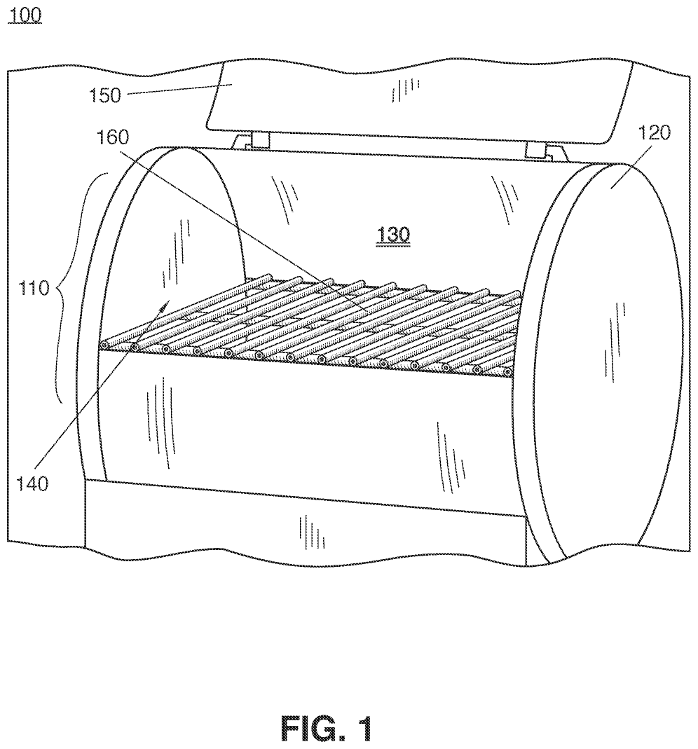

Reference will now be made to the drawings to describe various aspects of example embodiments of the invention. It is to be understood that the drawings are diagrammatic representations of such example embodiments, and are not limiting of the present invention, nor are they necessarily drawn to scale. FIG. 1 depicts a grilling apparatus 100 having a grilling and/or smoking compartment 110. The aforementioned grilling and/or smoking compartment 110 can have an outer wall 120 at least partially bounding an internal heating chamber 130 having an access opening 140 disposed therein. Grilling and/or smoking compartment 110 can also have a lid 150 that selectively covers access opening 140 and/or can be selectively operatable between an opened position (FIG. 1) and a closed position (not shown). Grilling and/or smoking compartment 110 can also house an improved grilling grate 160 mounted to an inner working surface thereto (not shown).

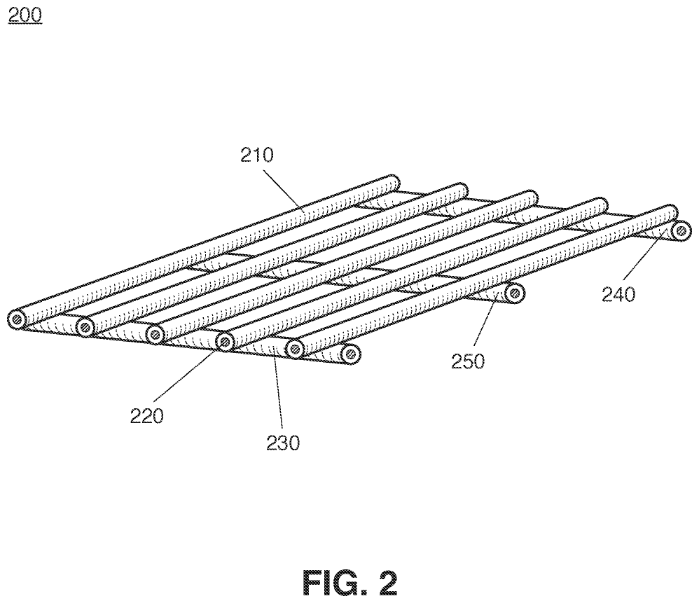

As shown in FIG. 2, a perspective view of a first embodiment of an improved grilling grate assembly 200 made in accordance with the principles of the present invention. The improved grilling grate assembly 200 comprises elongated placement rods 210 extending generally horizontally and generally parallel to one another. These elongated placement rods 210 are positioned such that there is sufficient space between each elongated rod to directly support foodstuffs over a heating source, such as a flame, fire, or smoke. The elongated placement rods 210 intersect the one or more elongated perimeter rods 230 and 240 and are affixed directly to the top working surface thereto, whereby one or more elongated crossbar rods 250 are affixed directly to the bottom working surface of the elongated placement rods 210 at their respective intersection points and whereby the elongated crossbar rods 250 are positioned in such a way that they run perpendicular to and intersect the elongated placement rods 210. The length of the elongated placement rods 210 and elongated crossbar rods 250 are such that they do not extend beyond the outer edge of the elongated perimeter rods 230 and 240.

The improved grilling grate 200 includes highly heat conductive elongated metal core material 220 encapsulated within each of the placement rods 210, perimeter rods 230 and 240, as well as the one or more crossbar rods 250 in order to maximize the optimal thermal conductivity of the present invention. Further, each of the placement rods 210, perimeter rods 230 and 240, as well as the one or more crossbar rods 250 provide a food-safe metal circumferential cladding to directly support foodstuffs to be cooked thereto.

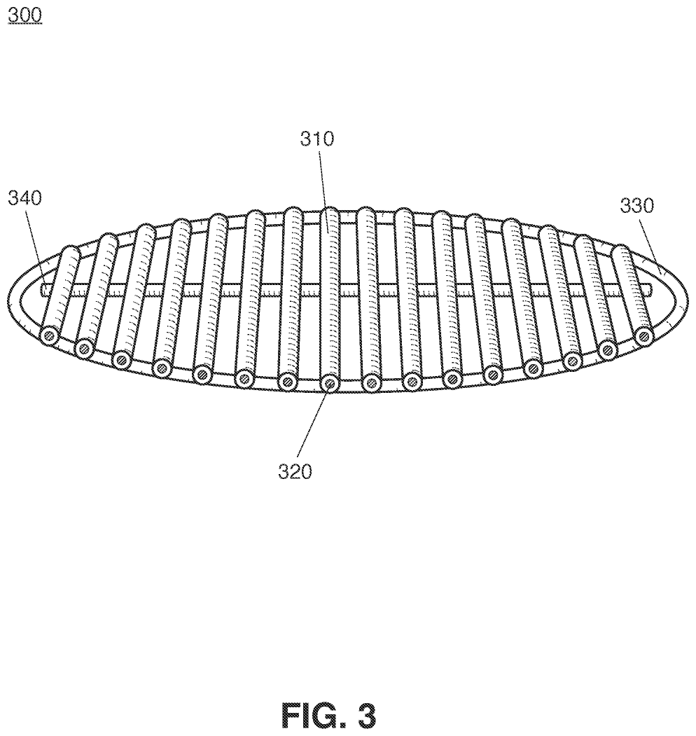

FIG. 3 shows another improved grilling grate assembly 300 made in accordance with the principles of the present invention. The improved grilling grate assembly 300 comprises elongated placement rods 310 extending generally horizontally and generally parallel to one another. These elongated placement rods 310 are positioned such that there is sufficient space between each elongated rod to directly support foodstuffs over a heating source, such as a flame, fire, or smoke. The elongated placement rods 310 intersect a circular perimeter rod ring 330 and are affixed directly to the top working surface thereto, whereby one or more elongated crossbar rods 340 are affixed directly to the bottom working surface of the elongated placement rods 310 at their respective intersection points and whereby the elongated crossbar rods 340 are positioned in such a way that they run perpendicular to and intersect the elongated placement rods 310. In certain instances, the elongated crossbar rods 340 intersect the inner working surface of the circular perimeter rod ring (not shown). The length of the elongated placement rods 310 and elongated crossbar rods 340 are such that they do not extend beyond the outer edge of the circular perimeter rod ring 330.

The improved grilling grate 300 includes highly heat conductive elongated metal core material 320 encapsulated within each of the placement rods 310, circular perimeter rod ring 330, as well as the one or more crossbar rods 340 in order to maximize the optimal thermal conductivity of the present invention. Further, each of the placement rods 310, circular perimeter rod ring 330, as well as the one or more crossbar rods 340 provide a food-safe metal circumferential cladding to directly support foodstuffs to be cooked thereto.

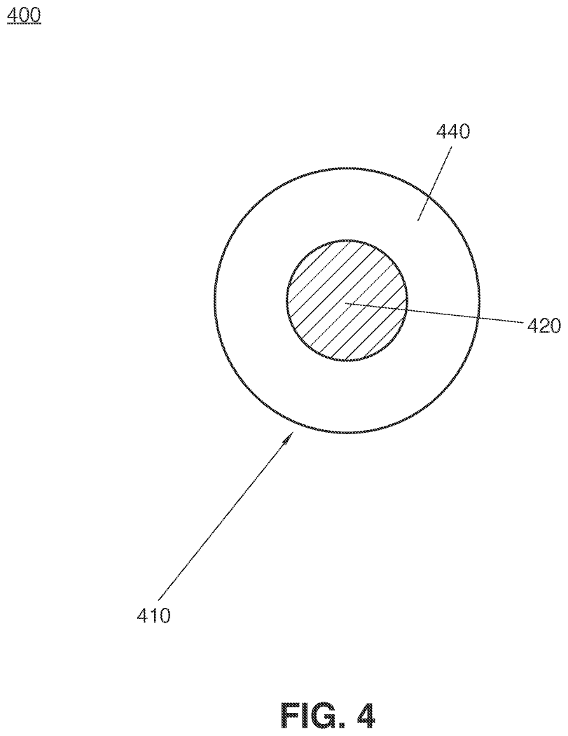

FIG. 4 shows a sectional view of a highly heat conductive elongated rod made in accordance with the principles of the present invention. The highly heat conductive elongated rod 400 as shown in FIG. 4 has a food-safe metal cladding 410 shown in sectional view as it would emerge from a forming roll mill and quenching operation. The food-safe metal clad rod 410 includes a highly heat conductive core material 420, around which one or more strips 440 of food-safe metal flat stock have been formed circumferentially. In certain instances, a thin barrier layer (not shown) is deposited by any metallurgical deposition means known to those skilled in the art, circumferentially onto the outside of the highly heat conductive core material 420 and is made of one or more metals in order to form a thin film coating in a deposited thickness of about 1 μm to about 1,000 μm, around which one or more strips 440 of food-safe metal flat stock have been formed circumferentially to form the highly heat conductive elongated rod 400 of the present invention.

It is to be understood that while reference is made to “grilling apparatuses,” “grilling,” “grills,” “smoking,” and the like, the present invention extends to other food preparation methods such as, but not limited to, baking, barbequing, braising, and roasting, as well as to apparatuses and systems for cooking, warming, and/or preparing foodstuffs in any conceivable manner.

Grilling apparatuses of the present invention can be heated using a variety of heat source types. For example, the present invention extends to grilling apparatuses configured with heat source types consisting of, but not limited to, briquettes, charcoal, electric, infrared, natural gas, propane, wood, or wood pellets. In some embodiments, the grilling apparatuses according to the present invention are configured to be mobile in connection with movement of the grilling apparatuses by means of wheels or other moving elements.

In other embodiments of the present invention, the grilling apparatuses may be non-mobile in connection with relatively permanent installation by means of securing to a wall and/or floor using methods known to those skilled in the art. In still other embodiments, the grilling apparatuses according to the present invention can be configured specifically for outdoor use. For example, various health and safety regulations may mandate the use of certain grilling apparatuses be used in outdoor, open-air environments, such as those that are away from building structures and overhanging vegetation.

There are many types of grilling apparatuses in use today, with three primary barbecue grill classifications: charcoal grills, gas grills, and pellet grills.

By way of non-limiting example, a charcoal grill consists of a generally hemispherical bowl that has a lower monometallic grilling grate to directly support the charcoal heat source material and an upper monometallic grilling grate to directly support foodstuffs to be cooked thereto. The aforementioned bowl is typically supported by a tripod leg arrangement. Following charcoal ignition, charcoal grills typically require 10-15 minutes of attendant waiting time for the charcoal to become hot enough to begin foodstuff cooking. Once the adequate charcoal temperature is achieved, the attendant can begin cooking, but even then, the achieved cooking temperature can be inconsistent and far from precise across the entire grill grate surface area. Should the attendant attempt to shortcut the typically required long charcoal heating time, they would likely be met with a cold grill that has foodstuffs resting on the cold monometallic grilling grate for an even longer duration of time, which creates the opportunity for undesirable dry, overcooked foodstuffs, as is especially true with meats, in addition to there being cold monometallic grilling grates that will very likely adhere non-desirably to the foodstuffs thereto.

In another non-limiting example, a gas grill consists of a cooking vessel having a lower gas burner assembly with either propane (LP) or natural gas (NG) as the heat source type, with an upper monometallic grilling grate to directly support foodstuffs to be cooked by either direct gas-flame or heated grilling elements which radiate the gas-flame heat necessary to cook the aforementioned foodstuffs thereto. Smaller gas grills are typically supported by a cart with wheels if they are portable, though larger stationary or industrial sized gas grills are typically installed in a relatively permanent manner such as by securing to a wall and/or floor by methods known to those skilled in the art. Gas grills overcome some of the disadvantages of charcoal grills by reaching foodstuff cooking temperatures slightly faster, with modest gains in both temperature accuracy and precision, however presently available gas grills continue to offer disadvantages in view of the present invention. In addition to foodstuffs adhering non-desirably to the typically monometallic cast iron grill grate surface thereof, known monometallic cast iron grill grates are prone to rusting and they require an excessive amount of attendant maintenance as a result.

In still another non-limiting example, a pellet grill consists of a convection oven having an electrically powered hopper and auger system for delivering wood pellet heat source fuel into a lower fire pot chamber covered with a heat shield within an oven, with an upper monometallic grilling grate to directly support foodstuffs to be cooked by grilling and/or smoking thereto. These types of grills are often supported by a four-leg arrangement with wheels for ease of mobility. Pellet grills overcome some of the disadvantages of both charcoal grills and gas grills with significant gains in both temperature accuracy and precision, provided that the convection oven chamber is closed, however, when the attendant opens the convection oven chamber to tend to the foodstuffs being cooked on the monometallic grilling grate thereto, the temperature can radically drop and then take considerable time to recover, even when the convection oven chamber is reclosed. By way of non-limiting example, a pellet grill with indirect convection heating can lose as much as or more than 100° F. through heat-loss in less than 60-seconds when the convection oven chamber in open during foodstuff cooking. Additionally, pellet grills often face difficulty with achieving the high temperature thresholds required for optimal grilling, especially given that their primary strength is in smoking foodstuffs with absolute consistency at the relatively low temperatures required for producing smoke, such as temperatures in the range of 145° F. to 275° F. This can be particularly true for the difficulties of pellet grills to properly sear meat since pellet grills operate exclusively with indirect heat and only typically reach maximum temperatures of around 500° F., whereas charcoal grills and gas grills operate with direct heat at much higher temperatures. Searing meat can be generally understood as the caramelization of the sugars and amino acids found within meats as they come in contact with high heat. Searing, browning, or charring, is technically known as a Maillard reaction, which can improve the color, flavor, and texture of the cooked meat. For these reasons and more, presently available pellet grills continue to offer disadvantages in view of the present invention.

Any alterations and further modifications of the inventive features illustrated herein, and any additional applications of the principles of the invention as illustrated herein, which would occur to one skilled in the relevant art and having possession of this invention, are to be considered within the scope of the invention.

It will be appreciated that certain embodiments may include, incorporate, or otherwise comprise features described in other embodiments disclosed and/or described herein. Accordingly, the various features of one embodiment can be compatible with, combined with, included in, and/or incorporated into other embodiments of the present invention. Invention of certain features relative to one embodiment of the present invention should not be construed as limiting application or inclusion of said features to the specific embodiment. Rather, it will be appreciated that other embodiments can also include said features without necessarily departing from the scope of the present invention. Moreover, unless a feature is described as requiring another feature in combination therewith, any feature described herein may be combined with any other feature of a same or different embodiment disclosed herein.

The food-safe metal cladded, highly heat conductive elongated rods assembled in a nesting relationship to form a grilling grate of the present invention overcome the limitations of low thermal conductivity found with many conventional monometallic elongated rod grilling grates or monometallic elongated bar grilling grates, such as stainless steel for example. Further, the aforementioned grilling grate of the present invention also overcomes many, if not all the attendant maintenance requirements of known monometallic grill grates, such as cast iron for example. In view of the present invention, thermal conductivity can be generally understood to be the ability of a grilling grate to absorb and hold heat. The better that a grilling grate absorbs and holds heat, and thereby the better it's thermal conductivity, the faster it will heat-up, the longer it will hold heat, the more evenly it can distribute that heat, as well as the higher the overall temperature that it can achieve, just to name a few of the known advantages. As this improved thermal conductivity of the grilling grate of mention relates to the foodstuffs being grilled and/or smoked thereon, this can potentially create attendant benefits such as shorter grilling and/or smoking times, as well as additional foodstuff benefits such as more evenly grilled and/or evenly smoked foodstuffs, in addition to instances where improved searing is achieved, and even more subjective benefits such as when improved or augmented foodstuff color, flavor, and texture may be enhanced.

As a non-limiting example, the present invention can be configured to have substantially higher thermal conductivity than conventionally known monometallic stainless steel elongated rod grilling grates, porcelain-coated or rustproof-coated monometallic elongated rod steel grilling grates, and even monometallic cast iron elongated bar grilling grates. By way of non-limiting example, monometallic stainless steel elongated rod grilling grates, likely the most popular grilling grate type in the world today, possesses thermal conductivity of about 15 Watts per meter-Kelvin. By contrast, the present invention can be configured to poses thermal conductivity anywhere between about 15 Watts per meter-Kelvin to about 400 Watts per meter-Kelvin in a bimetallic, highly heat conductive elongated rod grilling grate construction. The bimetallic grilling grate elongated rods of mention are created in a process known as metal cladding whereby a combination of two different metals become joined in a single elongated rod.

A non-limiting example of an improved grilling grate of the present invention would be that of stainless-steel cladded copper elongated rods assembled in a nesting relationship whereby the copper rod core is preferably between 0.5 mm and 10 mm in diameter, and more preferably between 2 mm and 4 mm in diameter. Further, the food-safe stainless-steel cladding of mention is preferably between 0.1 mm and 10 mm in diameter, and more preferably between 1 mm and 4 mm in diameter. Further still, the food-safe stainless-steel cladding of mention is preferably Type 304 stainless steel, Type 304L stainless steel, Type 430 stainless steel, Type 316 stainless steel, or Type 316L stainless steel, though any desired food-safe stainless-steel grade is acceptable within the scope of the present invention.

It is a first object of the present invention to harness the beneficial food-safe attributes and non-stick properties of stainless steel as a cladding material coupled with the high thermal conductivity properties of copper as a core material of the elongated grilling rods disposed within the improved grilling grate of the present invention. On average, copper is 20 times more thermally conductive than stainless steel, and in practical terms, this means that copper can distribute heat 20 times faster. In order to obtain the optimal thermal conductivity of the copper core of the bimetallic elongated grilling rods disposed within the grilling grate of the present invention, the copper core material requires greater than 99.9% purity. In order to confirm the optimal purity of the aforementioned copper core material prior to manufacturing components of the improved grilling grate of the present invention, an assay test is used to analyze the purity of the chosen material using methods known by those skilled in the art.

In furtherance of the first object of the present invention, preference is given to the use of oxygen-free copper with optimal purity in order to prevent blisters from forming within the metallurgically bonded food-safe stainless-steel cladding and highly conductive copper core material during the rod forming process. Unlike oxygen-free copper, ordinary copper can contain a small percentage of oxygen from about 0.04%, and when ordinary copper is subjected to the bimetallic rod forming and cladding process at high temperatures, there exists the opportunity for a gas to form at the bonding lining between the two metals which may be oxygen, carbon dioxide or steam, or a mixture thereof. This potential gas formed at the bonding line between the two metals is believed to be the primary contributing factor to cosmetic defects, or blisters being formed thereto. According to embodiments of the present invention, the aforementioned highly heat conductive copper core material must be encapsulated within the elongated grilling rods in order to prevent the copper from being exposed to direct food contact, and thereby removing the opportunity for the copper to potentially leach copper ions into the foodstuffs undesirably. By joining the beneficial properties of stainless-steel cladding and copper core material together for making the bimetallic elongated grilling rods disposed within the grilling grate of the present invention, the grilling and/or smoking foodstuff experience can be greatly improved. In practical terms, the grilling grate of the present invention radiates infrared heat, and it can amplify the heating temperature of the grilling apparatus by as much as or more than 100° F., while simultaneously distributing even heat across the entire grilling and/or smoking surface in a non-stick, non-rusting, low-to-no maintenance solution.

It is a second object of the present invention to provide a method of continuously producing the food-safe metal cladded, highly heat conductive elongated rods for disposing within an improved grilling grate in which the highly heat conductive elongated rod cores are of uniform diameter and the food-safe metal circumferential cladding is of uniform thickness, and both are formed into exact concentric forms. However, in certain instances it may be beneficial to have varying diameters of the highly heat conductive elongated rod cores of the highly heat conductive elongated rods disposed within an improved grilling grate depending on factors such as the grilling apparatus size, shape, heat source type, foodstuff type, and food preparation method.

Additional non-limiting examples of highly heat conductive core materials for use in producing the bimetallic elongated grilling rods disposed within the grilling grate of the present invention, may consist of cast iron, aluminum, anodized aluminum, alloys and combinations thereof. Further, the highly thermal conductive cores may be solid or stranded in their construction depending on factors such as the chosen grilling apparatus size, shape, heat source type, foodstuff type, and food preparation method.

Still further, the exterior metal cladding for use in producing the bimetallic elongated grilling rods disposed within the grilling grate of the present invention may be coated in one or more porcelain enamels or rustproof coatings in certain instances. And still further, in certain instances three or more metals may be joined in various configurations for producing multi-metallic elongated grilling rods disposed within the grilling grate of the present invention.

The plurality of food-safe metal cladded, highly heat conductive elongated rods assembled in a nesting relationship to form the grilling grate of the present invention may be oriented in any configuration provided that there is sufficient space between each elongated placement rod to directly support foodstuffs over a heating source, such as a flame, fire, or smoke. A non-limiting example of the plurality of food-safe metal cladded, highly heat conductive elongated rods orientation within the improved grill grate of the present invention could be to horizontally align and make parallel each of the aforementioned elongated placement rods such that the ever-popular foodstuff, hot dogs, cannot fall between the oriented elongated placement rods spacing, even when uncooked. This would be an advantageous configuration as it would minimize the chances of the aforementioned hot dogs from falling through the oriented elongated placement rods of previous mention, thereby preventing unwanted attendant detriments from occurring such as creating additional clean-up time, burned or blackened food, and the unwanted additional monetary expense of wasting foodstuffs.

According to one aspect of the present invention, there is provided a method for producing the food-safe metal cladded, highly heat conductive elongated rods assembled in a nesting relationship to form a grilling grate. By way of non-limiting example, a method of metal cladding the highly heat conductive elongated rods of the present invention consists of sourcing the desired gauge of a highly heat conductive elongated metal core input material, be it either rod or wire, and in either straight or stranded form. This is followed by configuring a straightening device configured to straighten the highly heat conductive elongated metal core input material. The aforementioned core material is then cleaned in order to remove impurities and oxide films to ensure maximum bonding strength, and an optional thin film barrier coating is applied. The next step is selecting a food-safe metal cladding material configured to provide one or more strips of food-safe metal cladding material to the now prepared core material. Further, one or more heating devices is configured to heat the optionally coated core material and the one or more strips of food-safe metal cladding material, whereby the heating temperature may be the same for both the cladding and core material or it may be different. This is followed by use of a forming roll mill configured to form the one or more strips of the food-safe metal cladding material around the optionally coated elongated rod core material circumferentially. Finally, quenching the now complete food-safe metal cladded, highly heat conductive elongated rods and cross-sectionally cutting the elongated rods to the desired lengths dependent upon the chosen grilling apparatuses dimensions and shape.

The metallurgical bond between the food-safe metal cladding material and the optionally coated elongated rod core material of the highly heat conductive elongated rods of the present invention is such that corrosion cannot advance at the boundary between the food-safe metal cladding material and the highly heat conductive core material. For example, even if the boundary was to be exposed to water, liquid grilling apparatus cleaner, or the like, the exposure could not penetrate the boundary layer. Furthermore, the food-safe metal cladding material can be restrained from being separated from the highly heat conductive core material boundary between them. To which, the food-safe metal cladding material and the highly heat conductive core material can be bonded with sufficient strength. By way of non-limiting example, a food-safe metal cladding of stainless steel and a highly heat conductive core material of copper can be metallurgically bonded circumferentially together in order to form an elongated rod of the present invention such that high bonding strength is achieved, and the stainless-steel cladding of mention cannot be peeled off at the bonding interface even when bending stress is applied. Even if the stainless-steel cladding of mention was to be worn away from the copper core of mention, the bonding interface would not be corroded selectively.

According to another aspect of the present invention, there is provided a method for producing the improved grilling grate of the present invention whereby the plurality of food-safe metal cladded, highly heat conductive elongated rods are assembled in a nesting relationship, whereby so-called elongated placement rods extend generally horizontally and generally parallel to one another. These elongated placement rods are positioned such that there is sufficient space between each elongated rod to directly support foodstuffs over a heating source, such as a flame, fire, or smoke. The elongated placement rods of mention intersect the one or more elongated outer edge rods, which are hereinafter known as the elongated perimeter rods, and are affixed directly to the top working surface thereto, whereby one or more elongated crossbar rods are affixed by their end points to the one or more elongated perimeter rods in such a way that they run perpendicular to and intersect the elongated placement rods. The one or more elongated crossbar rods of mention are in turn affixed directly to the bottom working surface of the elongated placement rods at their respective intersection points. The length of the elongated placement rods and elongated crossbar rods of mention are such that they contact the elongated perimeter rods, but do not extend beyond the elongated perimeter rods outer edge. All of the various grilling grate rods of mention are permanently welded into position at their respective intersection points by methods known to those skilled in the art. The number, size and diameter of the food-safe metal cladded, highly heat conductive elongated rods of the present invention will vary depending on factors such as the desired grilling apparatuses size, shape, heat source type, foodstuff type, and food preparation method.

While the foregoing detailed description makes reference to specific exemplary embodiments, the present invention may be embodied or implement in other specific forms without departing from its spirit or essential characteristics, and all such modifications or changes, if any, are intended to fall within the scope of this invention. Accordingly, the described embodiments, implementations, aspects, and/or features are to be considered in all respects only as illustrative and/or exemplary, and not restrictive. For example, various improved grilling grates and their components may have different combinations of sizes, shapes, configurations, features, and the like. Such differences described herein are provided primarily to illustrate that there exist a number of different manners in which improved grilling grates may be used, made, and modified within the scope of this invention. Different features have also been combined in some embodiments to reduce the illustrations required and are not intended to indicate that certain features are only compatible with other features. Thus, unless a feature is expressly indicated to be used only in connection with one or more other features, such features can be used interchangeably on any embodiment disclosed herein or modified in accordance with the scope of the present invention.

More specifically, while illustrative exemplary embodiments in this invention have been more particularly described, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based on the language employed in the claims and not limited to examples described in the foregoing detailed description, which examples are to be construed as non-exclusive. Moreover, any steps recited in any method or process described herein and/or recited in the claims may be executed in any order and are not limited to the order presented in the claims, unless otherwise stated in the claims. Accordingly, the scope of the invention should be determined solely by the appended claims and their legal equivalents, rather than by the descriptions and examples given above.

I claim:

1. A grilling grate for a grilling apparatus, comprising:
A plurality of food-safe metal cladded, highly heat conductive elongated rods assembled in a nesting relationship comprising:
Elongated placement rods extending generally horizontally and generally parallel to one another and with sufficient space between each rod to directly support foodstuffs over a heating source; and
The elongated placement rods intersect one or more elongated perimeter rods, whereby one or more elongated crossbar rods are affixed by their end points to the one or more elongated perimeter rods such that they run perpendicular to and intersect the elongated placement rods; and the one or more elongated crossbar rods are in turn affixed directly to the bottom working surface of the elongated placement rods at their respective intersection points.

2. The grilling grate of claim 1, wherein the elongated grill grate rods are comprised of a highly heat conductive metal core material encapsulated by a food-safe metal cladding.

3. The grilling grate of claim 1, wherein the elongated grill grate rods are partially comprised of a highly heat conductive core material that is rod or wire having a diameter of 0.5 mm and 10 mm.

4. The grilling grate of claim 1, wherein the elongated grill grate rods are partially comprised of a food-safe metal cladding having a diameter of 0.1 mm and 10 mm.

5. The grilling grate of claim 1, wherein the elongated grilling grate rods are comprised of a stainless-steel clad copper rod formed by encapsulating a core material of copper rod and an outer surface of the core material with a food-safe stainless-steel cladding.

6. The grilling grate of claim 1, wherein the elongated grilling grate rods are comprised of a stainless-steel clad anodized aluminum rod formed by encapsulating a core material of anodized aluminum rod and an outer surface of the core material with a food-safe stainless-steel cladding.

7. The grilling grate of claim 1, wherein the elongated grilling grate rods are comprised of a stainless-steel clad cast iron rod formed by encapsulating a core material of cast iron rod and an outer surface of the core material with a food-safe stainless-steel cladding.

8. A grilling grate for a grilling apparatus, comprising:
A plurality of food-safe metal cladded, highly heat conductive elongated rods assembled in a nesting relationship comprising:
Elongated placement rods extending generally horizontally and generally parallel to one another and with sufficient space between each rod to directly support foodstuffs over a heating source; and
The elongated placement rods intersect one or more elongated perimeter rods, whereby one or more elongated crossbar rods are affixed by their end points to the one or more elongated perimeter rods such that they run perpendicular to and intersect the elongated placement rods;
and the one or more elongated crossbar rods are in turn affixed directly to the bottom working surface of the elongated placement rods at their respective intersection points.

9. The grilling grate of claim 8, wherein the elongated grill grate rods are comprised of a highly heat conductive metal core material encapsulated by a metal cladding and a food-safe porcelain coating applied thereto.

10. The grilling grate of claim 8, wherein the elongated grill grate rods are partially comprised of a highly heat conductive core material that is rod or wire having a diameter of 0.5 mm and 10 mm.

11. The grilling grate of claim 8, wherein the elongated grill grate rods are partially comprised of a metal cladding having a diameter of 0.1 mm and 10 mm.

12. The grilling grate of claim 8, wherein the elongated grilling grate rods are partially comprised of a food-safe porcelain coating applied to the outer surface of the metal cladding having a thickness in the range of 1 to 25 mils.

13. The grilling grate of claim 8, wherein the elongated grilling grate rods are comprised of a steel-clad copper rod formed by encapsulating a core material of copper rod and an outer surface of the core material with a steel cladding and a food-safe porcelain coating applied thereto.

14. The grilling grate of claim 8, wherein the elongated grilling grate rods are comprised of a steel-clad anodized aluminum rod formed by encapsulating a core material of anodized aluminum rod and an outer surface of the core material with a steel cladding and a food-safe porcelain coating applied thereto.

15. The grilling grate of claim 8, wherein the elongated grilling grate rods are comprised of a steel-clad cast iron rod formed by encapsulating a core material of cast iron rod and an outer surface of the core material with a steel cladding and a food-safe porcelain coating applied thereto.
